(19) United States
(12) Patent Application Publication
(10) Pub. No.: US 2002/0060745 A1
(43) Pub. Date: May 23, 2002

(54) Outdoor dome

(75) Inventors: Rohn Bowden, Greensboro, NC (US); Wally Gordon, Winston-Salem, NC (US)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(73) Assignee: PHILIPS ELECTRONICS NORTH AMERICA CORPORATION

(21) Appl. No.: 09/749,175

(22) Filed: Dec. 27, 2000

Related U.S. Application Data
(60) Provisional application No. 60/221,399, filed on Jul. 28, 2000.

(51) Int. Cl. H04N 5/225

(52) U.S. Cl. 348/373; 348/151

(57) ABSTRACT

The invention provides a camera assembly which includes a housing having a mounting cap attached to sidewalls to which is attached an optical surface, the camera housing enclosing a camera system wherein the optical surface is rotatable relative to the camera housing after the camera system is positioned. Preferably, the optical surface is a dome rotatable relative to the housing through the use of a circumferential seal attached to a circumferential flange portion of the housing. Most preferably, the seal is a continuous, circumferential bi-level seal that is S-shaped in cross-section, said seal having a first level that includes a first groove that contains a circumferential flange portion of a wall portion of said housing, and a second level that includes a second groove that contains a circumferential flange portion of a wall of said dome.

This application claims the benefit of provisional application Serial No. 60/221,399 filed Jul. 28, 2000.

### FIELD OF THE INVENTION

This invention relates to indoor/outdoor surveillance equipment and systems, and more particularly, to an improved camera assembly that has a housing that includes a hemispherical window or dome.

### BACKGROUND OF THE INVENTION

Closed-circuit surveillance equipment is well established and can include fixed-position cameras and zoom lenses mounted on pan and tilt mechanisms that are typically controlled by security personnel. In outdoor locations, an enclosure for the camera housing is usually employed and domed housing for such cameras are desirable due to their appearance as well as the fact that the camera itself is not easily visible, though the camera can scan a wide area. Typically, the dome itself will be painted or tinted to be opaque except for a limited area or window through which the camera can see the outside surroundings.

In a typical outdoor camera enclosure, a single main housing part is utilized, wherein a top thereof is connected to a pipe. Electrical connections are generally routed from a main power source through the pipe and into the housing. In addition, a hemispheric dome and additional internal components, such as the camera power supply, camera body, lens, pan & tilt mechanism, and controller electronics, are removably attached to an inside of the single housing part. Such camera assemblies are subject to damage and require means to protect the camera from moisture and precipitation, extremes in temperature, and unauthorized tampering. For example, some conventional housings permit rainwater or other moisture to accumulate and run down the conical side of the housing and onto the dome itself. There are however, many security domes housings that have a rating of IPGS and NEMA4 which means, among other things, that these units protect the internal electronic components from water and dust damage. To our knowledge, these rated domes have no moving parts. Thus it is necessary to disassemble and remove the dome whenever it is necessary or desired to align the window with the camera.

### SUMMARY OF THE INVENTION

An object of the invention is to provide a camera assembly with a rotatable dome.

Another object of the invention is to provide a camera assembly with a rotatable dome and that also fulfill the criterion to qualify for IPGS and NEMA4 ratings.

Another object is to provide a camera assembly with a movable dome that protects against water and dust damage.

These and other objects of the invention are accomplished by a camera assembly having a housing which comprises a dome, preferably a substantially opaque dome with a transparent window, which dome can be rotated and moved. Preferably, the dome is made rotatable through the use of a seal, preferably a continuous, circumferential bi-level seal that is s-shaped in cross-section, said seal having a first level that defines and includes a first groove that contains and preferably envelopes a circumferential flange portion of a wall portion of said housing, and a second level that defines and includes a second groove that contains and preferably envelopes a circumferential flange portion of a wall of said dome, the dome being rotatable and movable in the first groove of the seal, and preferably, substantially fixed and immovable in the second groove.

### BRIEF DESCRIPTION OF THE DRAWINGS

FIG. 1 shows an external view of a first embodiment of a camera assembly of this invention;

FIG. 1B is a vertical cross-section of the embodiment illustrated in FIG. 1A taken along line A-A;

FIG. 2 is an enlarged sectional view of the dome of FIG. 1;

FIG. 3 is an enlarged view of a section X shown in FIG. 1B; and FIG. 4 is a top elevation view of the dome of FIG. 1.

### DETAILED DESCRIPTION OF PREFERRED EMBODIMENTS

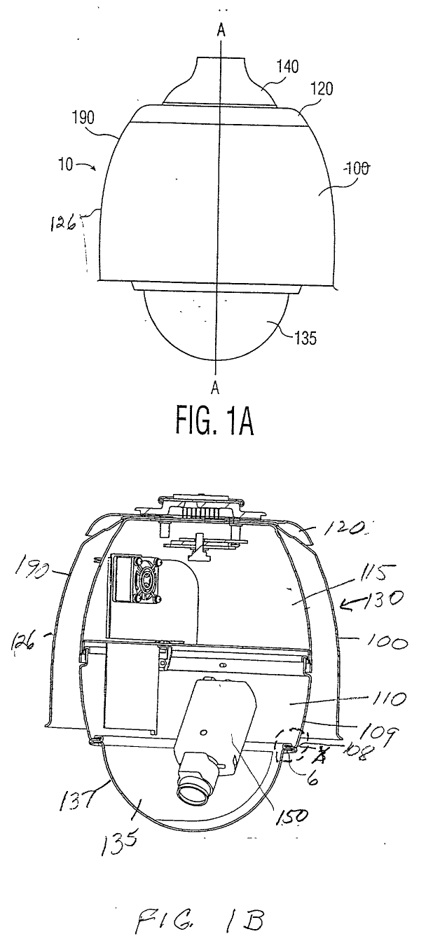

With reference to FIGS. 1A and 1B, there is illustrated a camera assembly 10 which comprises a mounting cap 140 attached to sidewalls 109, 126 which are in turn attached to an optical surface or dome 135 to form a camera housing 130 which surrounds a camera or lens component (including electronics) 150, all as is well known in the art.

If desired, the camera housing 130 may include an environmental shroud 190 which is effective to deflect heat energy, dissipate heat energy not reflected, protect the camera from water and/or other moisture, and enables a high level of heat dissipation even when the camera is operated in sunlight at high ambient temperature. According to a first embodiment of the invention illustrated in FIG. 1B, an environmental shroud 190 surrounds the camera housing 130 substantially completely and comprises a lower section 100 and an upper section 120. The lower section 100 of the shroud provides protection from radiant heat energy for the camera housing 130 and may include a coating on a surface thereof or the surface itself may be specified so that the emissivity is such that it reflects or deflects most of the radiant heat energy from the sun or any other hot body. Suitable coatings may include polyester, polyurethane, epoxy, transparent metallized polycarbonate coatings, aluminum foil inside various transparent materials, cold rolled steel, powder coatings, etc.

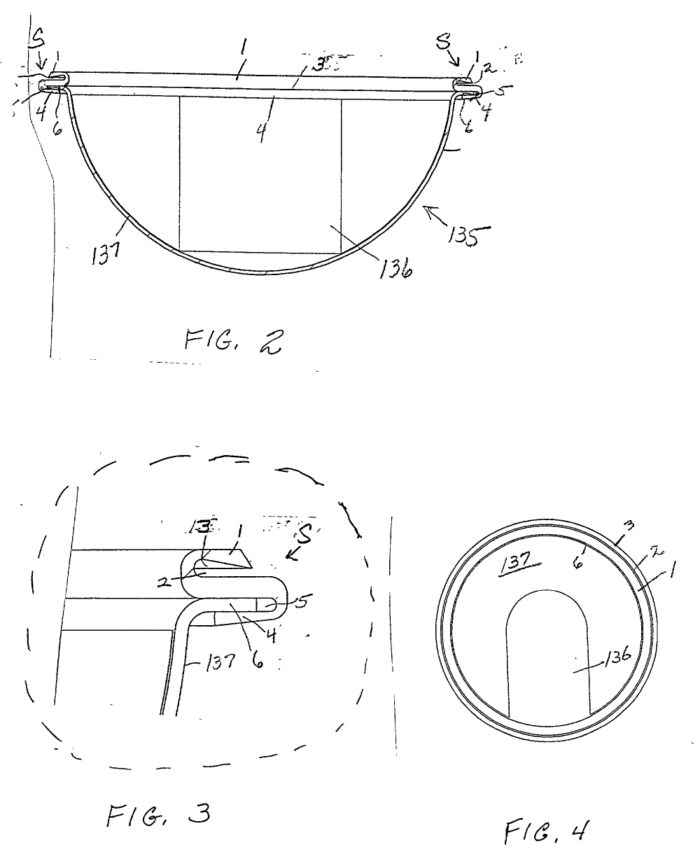

The housing 130 comprises an upper portion 115 and a lower portion 110 that includes a sidewall 109. With reference to FIG. 2 to 4, the optical surface or a substantially opaque dome 135 with a transparent window 136 and sidewalls 137 is movably attached to the housing sidewall 109 of lower housing portion 110 through the use of a seal S, preferably a continuous, circumferential bi-level seal that is S-shaped in cross-section, said seal having a first level 1 that defines and includes a first groove 2 that contains and preferably envelopes a circumferential flange portion 3 of a wall portion of said lower housing portion 110, and a second level 4 that defines and includes a second groove 5 that contains and preferably envelopes a circumferential flange portion 6 of a wall 137 of said dome 135, the dome being rotatable and movable in the first groove 2 of the seal S, and preferably, being substantially fixed and immovable in the second groove 5 of the seal.

The camera assemblies of the invention may be mounted as a pendant mount or as a wall mount as is known in the art. After the wall mount or pendant mount is established, the housing is opened and the camera is mounted in the housing. Once the camera is mounted, it is aimed in the general area of the surveillance, and the housing is closed. The dome is covered from the inside to hide the camera. Once the housing is closed, in accordance with the invention, the dome may be rotated to position the viewing area of the dome to coincide with the position of the camera. In the past, disassembling the dome from the housing and reassembly would be necessary to make any adjustments in the position of the dome window 136 and the position of the camera 110 relative to each other.

Camera assemblies for outdoor use are tested to determine if they meet the industry standard IP65 rating. To meet this standard, a series of tests are conducted including a test wherein the assembly is sprayed with pressurized water and dust over a period of time. Assemblies that do not meet the criterion of this test cannot be rated for outdoor use. The camera assemblies of this invention have been found to be eminently qualified and readily meet this test.

While the invention has been described for convenience, in the context of outdoor surveillance cameras, it will be understood that the invention is not limited to these embodiments. The camera assemblies of the invention may be used in any context where it is necessary to protect the contents of a housing from moisture and heat or dust, for example enclosed lighting, electronic equipment, other surveillance equipment such as switches, multiplexers, etc. Additionally, the invention may be embodied in other specific forms without departing from the spirit and scope or essential characteristics thereof, the present disclosed examples being only preferred embodiments thereof.

We claim:

1. A camera assembly which comprises:
a housing having a mounting cap attached to sidewalls to which is attached an optical surface, the camera housing enclosing a camera system wherein the optical surface is rotatable relative to the camera housing after the camera system is positioned.

2. A camera assembly having a housing which comprises an optical dome rotatable relative to the housing through the use of a circumferential seal attached to a circumferential flange portion of the housing.

3. A camera assembly as claimed in claim 2, wherein the seal is a continuous, circumferential bi-level seal that is S-shaped in cross-section, said seal having a first level that includes a first groove that contains a circumferential flange portion of a wall portion of said housing, and a second level that includes a second groove that contains a circumferential flange portion of a wall of said dome.

4. A camera assembly as claimed in claim 3, wherein the dome is rotatable in the first groove of the seal, and substantially fixed and immovable in the second groove.

5. A camera assembly as claimed in claim 1, wherein the dome is a substantially opaque dome with a transparent window, which dome can be rotated to align the camera assembly position with the transparent window.

6. A camera assembly which comprises:
a camera housing having a mounting cap attached to a top wall, and sidewalls to which is attached an optical surface, the camera housing enclosing a camera system;
an environmental shroud attached to the camera housing and effective to reflect and/or deflect heat energy, dissipate heat energy not reflected or deflected, and protect the camera housing from the ingress of moisture, and
an optical dome rotatable relative to the housing through the use of a circumferential seal attached to a circumferential flange portion of the housing.

7. A camera assembly as claimed in claim 6, wherein the seal is a continuous, circumferential bi-level seal that is S-shaped in cross-section, said seal having a first level that includes a first groove that contains a circumferential flange portion of a wall portion of said housing, and a second level that includes a second groove that contains a circumferential flange portion of a wall of said dome.

8. A camera assembly as claimed in claim 7, wherein the dome is rotatable in the first groove of the seal, and substantially fixed and immovable in the second groove.

9. A camera assembly as claimed in claim 6, wherein the dome is a substantially opaque dome with a transparent window, which dome can be rotated to align the camera assembly position with the transparent window.
